(19) United States
(12) Patent Application Publication
(10) Pub. No.: US 2020/0076095 A1
(43) Pub. Date: Mar. 5, 2020

(54) Electrical Wiring Junction Ball

(71) Applicant: George Cavazos, Weslaco, TX (US)

(72) Inventor: George Cavazos, Weslaco, TX (US)

(21) Appl. No.: 15/946,369

(22) Filed: Aug. 31, 2018

(51) Int. Cl. H01R 4/70; H01R 4/22

(52) U.S. Cl. CPC H01R 4/70; H01R 4/22

(57) ABSTRACT

An Electrical Component that simplifies and secures the connectivity of wiring connections. Can be used on all junctions that are exposed with simply opening housing and shutting it over wire connections and/or on new wiring junctions when extending or relocating a switch or outlet and when wiring is not extending to reach its new end destination. This product provides a quick and efficient method of connecting electrical wiring while meeting all applicable National Electrical Standards

### SPECIFICATIONS

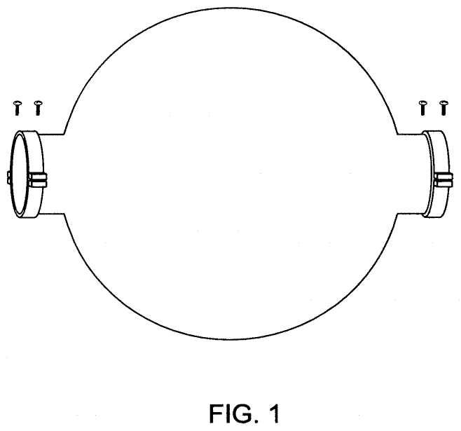

FIG. 1: This Product is currently drawn as a sphere. It can vary in shape to an oval or cylinder and vary in size as this product can be used for the different type of wiring there is to accommodate. For Example, this size drawing can work for a wire that is descriptive but not limited to a 14/3, 14/2, 12/2, 12/3, 10/3, 10/2 wire. Current Illustration shows a 3″ outer diameter sphere, perfect to fit inside any 2×4 wall or greater, and has 2 half cylinder ports measuring 1′ outer diameter for wiring entry. Side Half Cylinder Ports clamp functionality. This will allow the insert of the wire through its ports and hold the wire in place. Optional: a split of the side cylinder ports/clamps to open in half will allow already twisted wiring to be inserted in junction ball without disconnecting wiring connection.

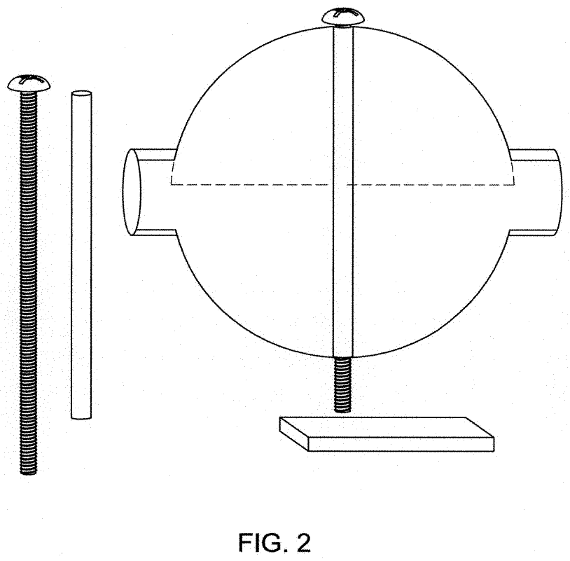

FIG. 2: Guard to Protect Wiring Perforation. In the event that an electrician wants to anchor this product, this product has a plastic cylinder that can be inserted in the center of the sphere to pass through a screw of any type within its top and bottom notch-outs and that is longer than the product to then anchor to its nearest stud. The Plastic cylinder will guide the screw without compromising that the screw can perforate the wires and cause an electrical shortage.

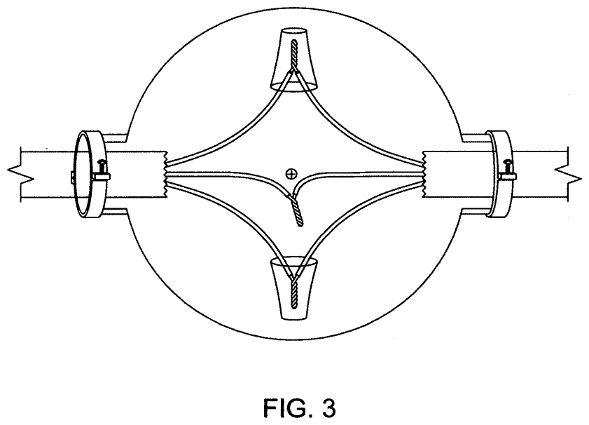

FIG. 3: Wiring Diagram. The illustration will show the simplicity of a 12/2 wire being junction with a twist on wire connector and closing Wiring Junction Ball for the wiring to be safe guarded from any exterior elements.

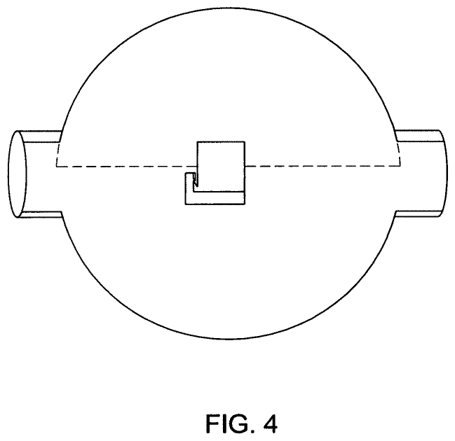

FIG. 4: Front. Demonstrates a dotted line that gives a visual of the section that opens and its ½″ surface latch for closing at its 9/16″ custom indented hook

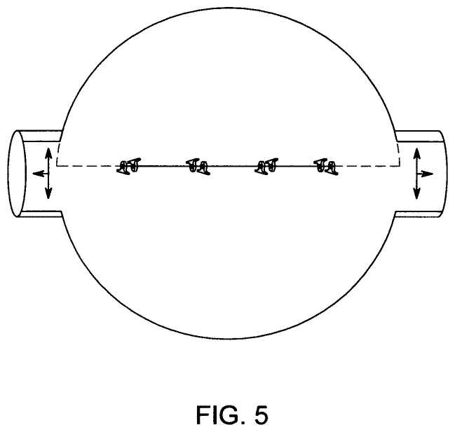

FIG. 5: Back. Demonstrates a dotted line that gives a visual of the Top piece with bottom piece, and 4 Top Loops with 4 Bottom loops that centrally align with a pin to function as a hinge and allow the opening and closing of this product while staying together as a whole product.

1: I claim a PVC Spherical or Oval Hollow design housing that opens and closes in half.

2: The Object of claim 1 has two sides insert for electrical wiring to pass through or insert-in and clamp wire in placed.

3: The Object can be anchored to the nearest fixed area or structure stud with 1 screw that Passes through the center of claim 1 through a thin insert-able cylinder guide that prevents perforation of junction wires.

4: I claim this object can be water sealed with a gasket or silicon on all opening areas.
